(19) United States
(12) Patent Application Publication
(10) Pub. No.: US 2013/0272482 A1
(43) Pub. Date: Oct. 17, 2013

(54) PRESSURIZED WATER REACTOR FUEL ASSEMBLY GRID

(71) Applicants: Patrick A. Hellandbrand, JR., Tolland, CT (US); Paul Evans, Chapin, SC (US); Dustin E. Staub, Leesville, SC (US)

(72) Inventors: Patrick A. Hellandbrand, JR., Tolland, CT (US); Paul Evans, Chapin, SC (US); Dustin E. Staub, Leesville, SC (US)

(73) Assignee: WESTINGHOUSE ELECTRIC COMPANY LLC, Cranberry Township, PA (US)

(21) Appl. No.: 13/445,123

(22) Filed: Apr. 12, 2012

(51) Int. Cl. G21C 3/356; G21C 3/352

(52) U.S. Cl. 376/442

(57) ABSTRACT

A nuclear pressurized water reactor fuel assembly grid that has a plurality of spring-like, resilient, cantilevered members that extend, substantially adjacent each other, from a wall of a grid cell that supports the fuel rods, into the support cell, with a distal end of each member being compressed by the fuel rod passing through the cell so as to exert a lateral force on the fuel rod. The plurality of cantilevered members replace conventional dimples employed in fuel assembly grid support cells.

### BACKGROUND OF THE INVENTION

1. Field

This invention pertains generally to a pressurized water nuclear reactor fuel assembly and, more particularly, to such a nuclear fuel assembly that employs a spacer grid that minimizes flow-induced vibration.

2. Description of the Related Art

The primary side of nuclear reactor power generating systems which are cooled with water under pressure comprises a closed circuit which is isolated from and in heat exchange relationship with a secondary circuit for the production of useful energy. The primary side comprises the reactor vessel enclosing a core internal structure that supports a plurality of fuel assemblies containing fissile material. The primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump and a system of pipes which are connected to the vessel form a loop of the primary side.

For the purpose of illustration, FIG. 1 shows a simplified nuclear reactor primary system, including a generally cylindrically reactor pressure vessel 10 having a closure head 12 enclosing a nuclear core 14. A liquid reactor coolant, such as water, or borated water, is pumped into the vessel 10 by pump 16 through the core 14 where heat energy is absorbed and is discharged to a heat exchanger 18, typically referred to as a steam generator, in which heat is transferred to a utilization circuit (not shown), such as a steam driven turbine generator. The reactor coolant is then returned to the pump 16, completing the primary loop. Typically, a plurality of the above described loops are connected to a single reactor vessel 10 by reactor coolant piping 20.

An exemplary reactor design is shown in more detail in FIG. 2. In addition to the core 14 comprised of a plurality of parallel, vertical, co-extending fuel assemblies 22, for purpose of this description, the other vessel internal structures can be divided into the lower internals 24 and the upper internals 26. In conventional designs, the lower internals' function is to support, align and guide core components and instrumentation as well as direct flow within the vessel. The upper internals restrain or provide a secondary restraint for the fuel assembly 22 (only two of which are shown for simplicity in FIG. 2), and support and guide instrumentation and components, such as control rods 28. In the exemplary reactor shown in FIG. 2, coolant enters the reactor vessel through one or more inlet nozzles 30, flows down through an annulus between the reactor vessel and the core barrel, is turned 180° in a lower plenum 34, passes upwardly to a lower support plate 37 and lower core plate 36 upon which the fuel assemblies are seated and through and about the fuel assemblies 22. In some designs, the lower support plate 37 and the lower core plate 36 are replaced by a single structure, a lower core support plate having the same elevation as 37. The coolant flow through the core and surrounding area 38 is typically large on the order of 400,000 gallons per minute at a velocity of approximately 20 feet per second. The resulting pressure drop and frictional forces tend to cause the fuel assemblies to rise, which movement is restrained by the upper internals, including a circular upper core plate 40. Coolant exiting the core 14 flows along the underside of the upper core plate 40 and upwardly through a plurality of perforations 42. The coolant then flows upwardly and radially to one or more outlet nozzles 44.

The upper internals 26 can be supported from the vessel or the vessel head and include an upper support assembly 46. Loads are transmitted between the upper support assembly 46 and the upper core plate 40, primarily by a plurality of support columns 48. A support column is aligned above a selected fuel assembly 22 and perforations 42 in the upper core plate 40.

Rectilinearly moveable control rods 28, which typically include a drive shaft 50 and a spider assembly 52 of neutron poison rods, are guided through the upper internals 26 and into aligned fuel assemblies 22 by control rod guide tubes 54. The guide tubes are fixedly joined to the upper support assembly 46 and the top of the upper core plate 40. The support column 48 arrangement assists in retarding guide tube deformation under accident conditions which could detrimentally affect control rod insertion capability.

FIG. 3 is an elevation view, represented in vertically shortened form, of a fuel assembly being generally designated by reference character 22. The fuel assembly 22 is the type used in a pressurized water reactor and has a structural skeleton which, at its lower end, includes a bottom nozzle 58. The bottom nozzle 58 supports the fuel assembly 22 on the lower core plate 36 in the core region of the nuclear reactor. In addition to the bottom nozzle 58, the structural skeleton of the fuel assembly 22 also includes a top nozzle 62 at its upper end and number of guide tubes or thimbles 84 which align with the guide tubes 54 in the upper internals. The guide tubes or thimbles 84 extend longitudinally between the bottom and top nozzles 58 and 62 and at opposites ends are rigidly attached thereto.

The fuel assembly 22 further includes a plurality of transverse grids 64 axially spaced along and mounted to the guide thimbles 84 and an organized array of elongated fuel rods 66 transversely spaced and supported by the grids 64. A plan view of the grid 64 without the guide thimbles 84 and fuel rods 66 is shown in FIG. 4. The guide thimbles 84 pass through the cells labeled 96, except for the center location which is reserved for the instrument tube 68, and the fuel rods occupy the cells 94. As can be seen from FIG. 4, the grids 64 are conventionally formed from an array of orthogonal straps 86 and 88 that are interleaved in an egg-crate pattern with the adjacent interface of four straps defining approximately square support cells through which the fuel rods 66 are supported in the cells 94 in transverse, spaced relationship with each other. In many designs, springs 90 and dimples 92 are stamped into the opposite walls of the straps that form the support cells 94. The springs and dimples extend radially into the support cells and capture the fuel rods 66 therebetween; exerting pressure on the fuel rod claddings to the hold the rods in position. The orthogonal array of straps 86 and 88 is welded at each strap end to a bordering strap 98 to complete the grid structure 64. Also, the assembly 22, as shown in FIG. 3, has an instrumentation tube 68 located in the center thereof that extends between and is captured by the bottom and top nozzles 58 and 62. With such an arrangement of parts, fuel assembly 22 forms an integral unit capable of being conveniently handled without damaging the assembly of parts.

As mentioned above, the fuel rods 66 in the array thereof in the assembly 22 are held in spaced relationship with one another by the grids 64 spaced along the fuel assembly length. Each fuel rod 66 includes a plurality of nuclear fuel pellets 70 and is closed at its opposite ends by upper and lower end plugs 72 and 74. The pellets 70 are maintained in a stack by a plenum spring 76 disposed between the upper end plug 72 and the top of the pellet stack. The fuel pellets 70, composed of fissile material, are responsible for creating the reactive power of the nuclear reactor. The cladding which surrounds the pellets functions as a barrier to prevent the fission by-products from entering the coolant and further contaminating the reactor system.

To control the fission process, a number of control rods 78 are reciprocably moveable in the guide thimbles 84 located at predetermined positions in the fuel assembly 22. The guide thimble locations can be specifically seen in FIG. 4 represented by reference character 96, except for the center location which is occupied by the instrumentation tube 68. Specifically, a rod cluster control mechanism 80, positioned above the top nozzle 62, supports a plurality of control rods 78. The control mechanism has an internally threaded cylindrical hub member 82 with a plurality of radially extending flukes or arms 52 that form the spider previously noted with regard to FIG. 2. Each arm 52 is interconnected to a control rod 78 such that the control rod mechanism 80 is operable to move the control rods vertically in the guide thimbles 84 to thereby control the fission process in the fuel assembly 22, under the motive power of a control rod guide shaft 50 which is coupled to the control rod hub 80 all in a well known manner.

As mentioned above, the fuel assemblies are subject to hydraulic forces that exceed the weight of the fuel rods and thereby exert significant forces on the fuel rods and the assemblies. In addition, there is significant turbulence in the coolant in the core caused by mixing vanes on the upper surfaces of the straps of many grids which promote the transfer of heat from the fuel rod cladding to the coolant. The substantial flow forces and turbulence can result in resonant vibration of the grid straps which can cause severe fretting of the fuel rod cladding if the relative motion between the grid strap and the fuel rod is not restrained. Fretting of the fuel rod cladding can lead to a breach and expose the coolant to the radioactive by-product within the fuel rods. Another potential problem with resonant grid strap vibration is that fatigue could occur in the grid straps causing grid strap cracking (or other damage to the straps).

Thus, an improved means of supporting the fuel rods within the fuel assembly grid is desired that will better resist resonant vibration of the grid straps.

### SUMMARY

The embodiments described hereafter achieve the foregoing objective by providing an enhanced nuclear fuel assembly for supporting a spaced, parallel array of a plurality of elongated fuel rods between a lower nozzle and an upper nozzle. A plurality of improved support grids are arranged within the fuel assembly, in tandem spaced along the axial length of the fuel rods, between the upper nozzle and the lower nozzle, at least partially enclosing an axial portion of the circumference of each fuel rod extending within a support cell of the support grids, to maintain the lateral spacing between the fuel rods. At least one of the support grids comprises a plurality of elongated, intersecting straps that define the support cells at the intersection of each four adjacent straps that surrounds the nuclear fuel rods. A length of each strap along its elongated dimension, between the intersections of the four adjacent straps, forms a wall of the corresponding support cells with at least one wall of the support cell having a dimple extending into the support cell. The dimple comprises a plurality of spring-like, resilient, cantilevered members that extend, substantially adjacent each other, from the walls into the support cells with a distal end of each member being compressed by the fuel rod passing through the support cell so as to exert a lateral force on the fuel rod.

Preferably, when the cantilevered members are in a fully extended position within the support cell, without the fuel rod positioned within the support cell, the cantilevered members are spaced from each other. When the cantilevered members are compressed by the fuel rod extending through the support cell the cantilevered members abut against each other to resist further movement towards the wall from which the cantilevered members extend. In one embodiment, the cantilevered members abut against each other at a distal end, wherein the distal end includes a tip and sides and the cantilevered members touch at the sides of the distal ends with the tips spaced from the ends of the other cantilevered members. Preferably, in such a condition, a space remains between adjacent cantilevered members along a portion of a side of each member that adjoins the wall.

In still another embodiment, the distal end is bent, i.e., flattened, to extend substantially parallel to the surface of the fuel rod extending through the cell, that the distal end contacts, to increase the surface area over which contact is made. Desirably, the cantilevered members each have two legs that are connected at one end in a generally L-shape, resembling a boomerang, with a distal end of each leg connected to the wall of the support cell and with the wall and legs of each cantilevered member defining a generally triangular shaped opening bordered by an inner surface of the legs and the adjacent wall of the support cell.

In one embodiment, the dimple is generally hemispherical in shape. In still another embodiment, an outline of the dimple is generally oval in shape. Desirably, the dimple is formed from four cantilevered members and, preferably, the distal ends of the cantilevered members are rounded. The fuel assembly provided for herein may also employ one or more such dimples on each of the walls of the support cell. The concept claimed hereafter also contemplates a nuclear power generating system having a nuclear reactor including such a fuel assembly.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which the embodiments described hereafter can be applied;

FIG. 2 is an elevational view, partially in section, of a nuclear reactor vessel and internal components to which the embodiments described hereafter can be applied;

FIG. 3 is an elevational view, partially in section, of a fuel assembly illustrated in vertically shortened form, with parts broken away for clarity;

FIG. 4 is a plan view of an egg-crate support grid that can employ the embodiments described hereafter;

FIG. 5 is a schematic view of one embodiment of the fuel assembly grid dimple described hereafter, in an uncompressed state;

FIG. 6 is a plan view of the dimple shown in FIG. 5, partially in section taken along the lines 6-6 thereof;

FIG. 7 is a schematic view of the dimple shown in FIG. 5 in a compressed state;

FIG. 8 is a plan view of the dimple shown in FIG. 7, partially in section taken along the line 8-8 thereof;

FIG. 9 is a schematic view of a second embodiment described hereafter; and

FIG. 10 is a plan view of the embodiment illustrated in FIG. 9, partially in section taken along the line 10-10 thereof.

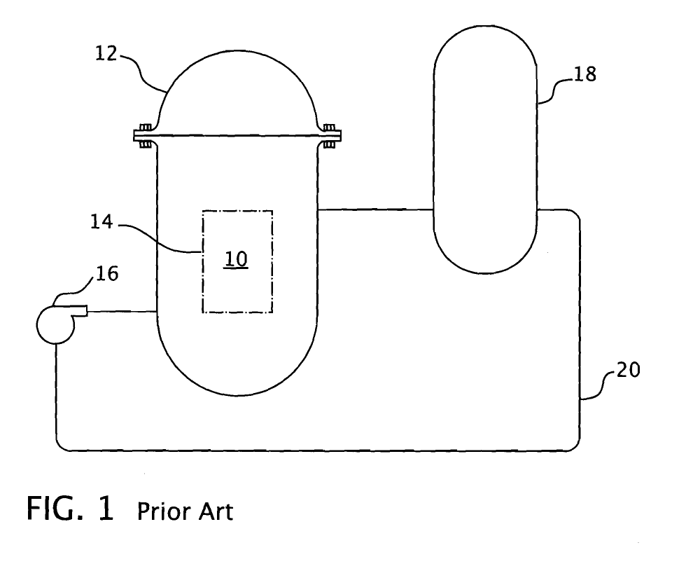

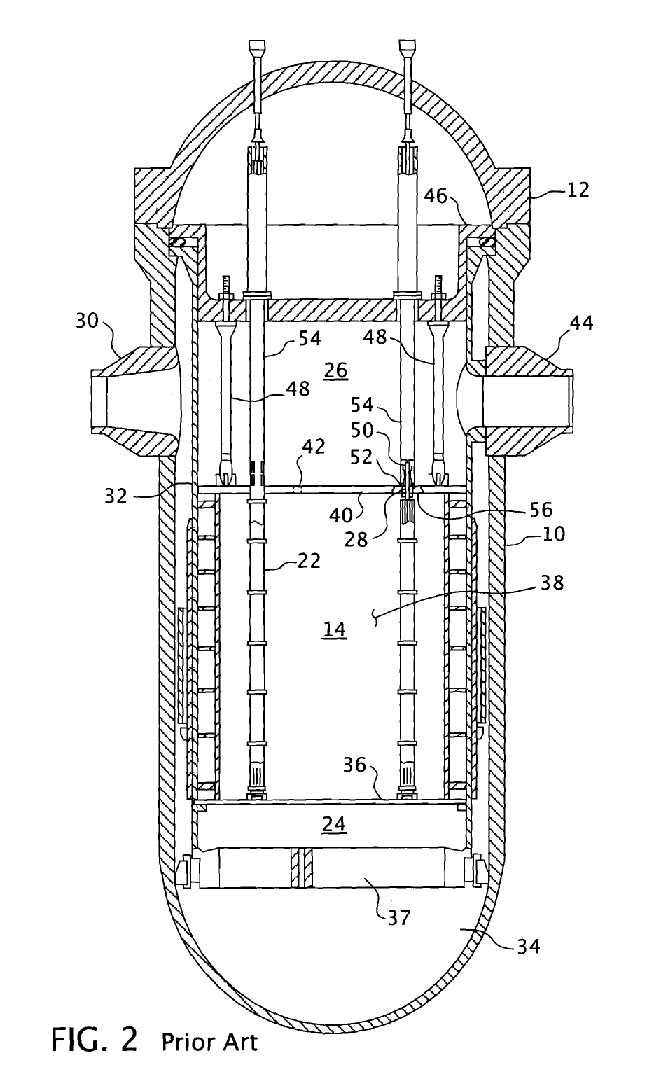

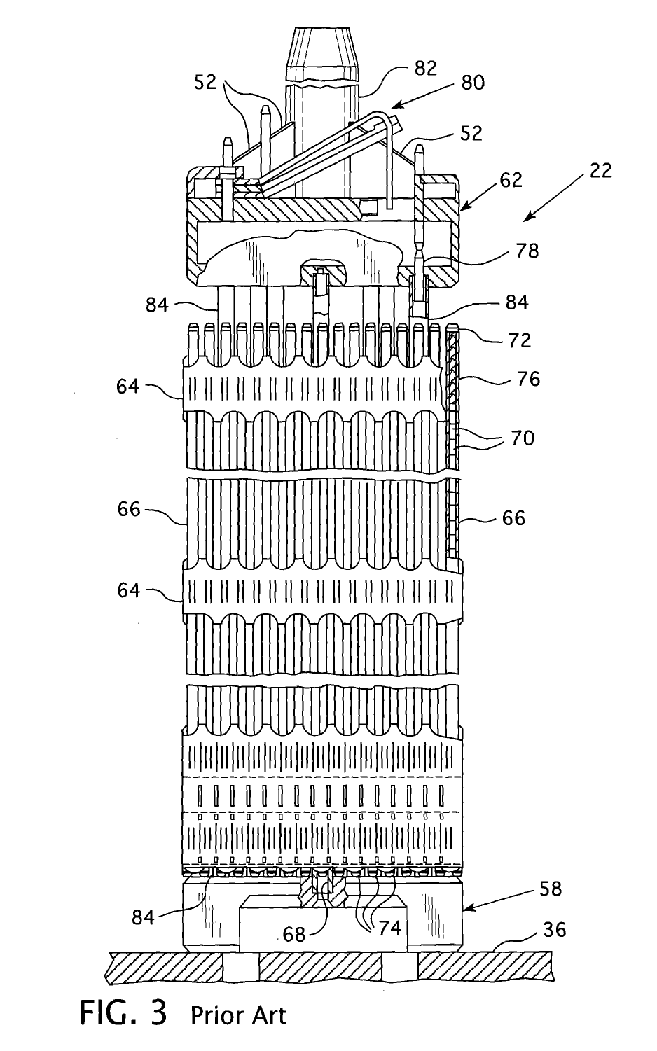

### DESCRIPTION OF THE PREFERRED EMBODIMENTS

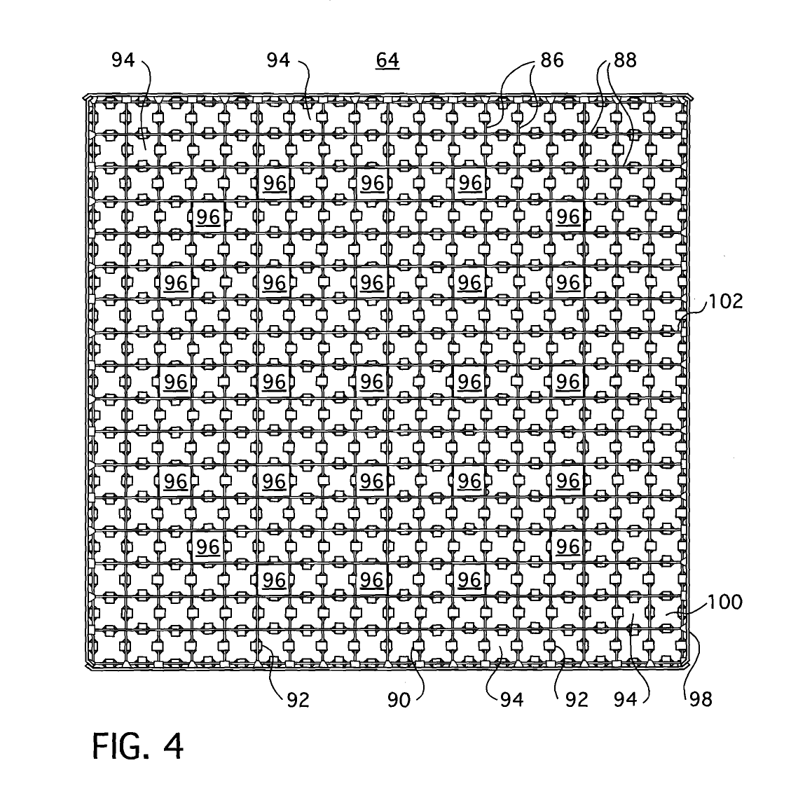

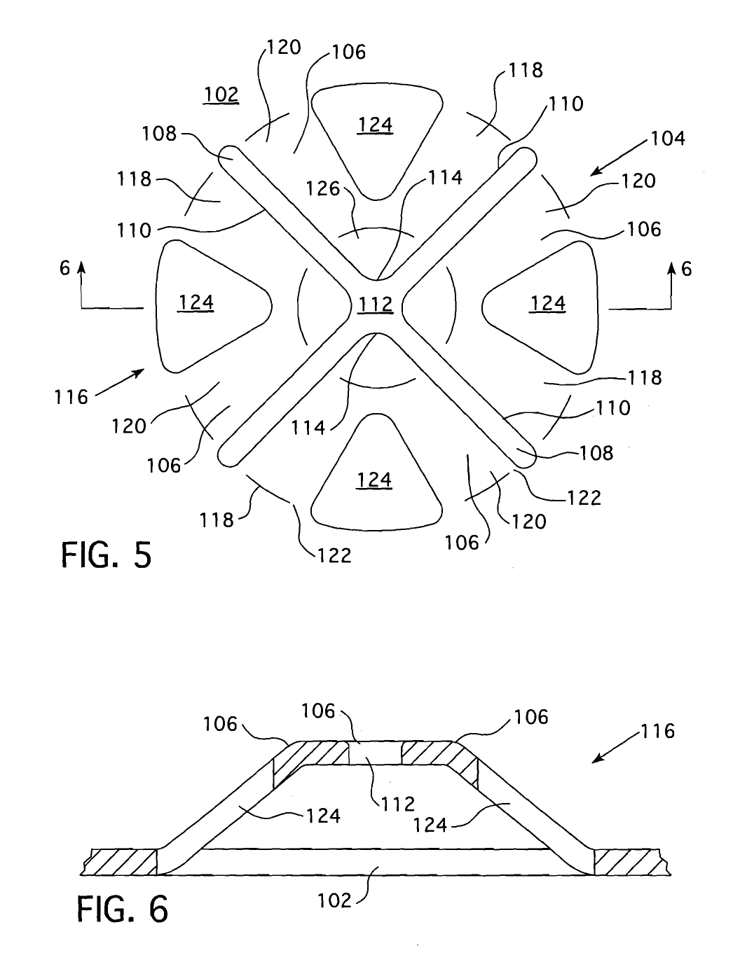

The invention claimed hereafter provides a new fuel assembly for a nuclear reactor and, more particularly, an improved spacer grid design for a pressurized water nuclear fuel assembly. The improved grid is generally formed from a matrix of approximately square cells, some of which 94 support fuel rods while the others of which 96 are connected to guide thimbles 84 and a central instrumentation tube 68. The plan view shown in FIG. 4 looks very much like the prior art grids since the surface contour of the individual grid straps 86 and 88 are not readily apparent from this view, but can be better appreciated from the views shown in FIGS. 5-10 which show just two of many embodiments which can incorporate the principals claimed hereafter. The grids employing the embodiment shown in FIG. 4 are formed from two orthogonally positioned sets of parallel, spaced straps 86 and 88, that are interleaved in a conventional manner and surrounded by an outer strap 98 to form the structural make-up of the grids 64. Though orthogonal straps 86 and 88 are shown forming a substantially square grid configuration, it should be appreciated that this invention can be applied equally as well to other grid configurations, e.g., hexagonal grids. The orthogonal straps 86 and 88, and in the case of the outer rows, the outer strap 98 define the support cells 94 at the intersection of each four adjacent straps that surround the nuclear fuel rods 66. A length of each strap along the straps elongated dimension, between the intersection of four adjacent straps, forms a wall 102 of the fuel rod support cells 94.

As previously mentioned, due to the high velocity of the coolant passing upwardly through the core and the turbulence that is generally, intentionally created to promote heat transfer from among the fuel assemblies to the coolant, the nuclear fuel assembly grid straps 86 and 88 and the fuel rods 66 have a potential to vibrate which can cause fretting of the cladding and eventually result in a breach of the cladding and release of fission by-products into the coolant. The improved grid straps illustrated in FIGS. 5-10 provide examples of the application of the concepts claimed hereafter that enhance support for the fuel rods to minimize differential movement between the fuel rods and the grid straps. To that end, the inventions claimed hereafter provide a plurality of cooperating cantilevered springs in place of conventional dimples/arch and spring support features in the grid strap walls. At some point the cooperating cantilevered springs, after deflection by the fuel rods, close up and go solid to substantially function as a conventional arch/dimple. The cantilevered springs provided for herein are referred to herein as SPARCH™ (combined SPring/ARCH support feature) to distinguish them from traditional grid springs. The SPARCH™ is a multi-cantilevered variable rate spring support that behaves like an arch/dimple after being deflected a certain distance. The SPARCH™ can be employed to replace just the arch/dimples in a conventional spacer grid cell or it can be used to replace both arch/dimple and spring support features that are currently used in a typical spacer grid. The SPARCH™ provides a variable rate spring support for a fuel rod at all four sides of each grid cell and maintains a rod pitch if the SPARCH™ is deflected to its solid form during accident conditions or seismic events.

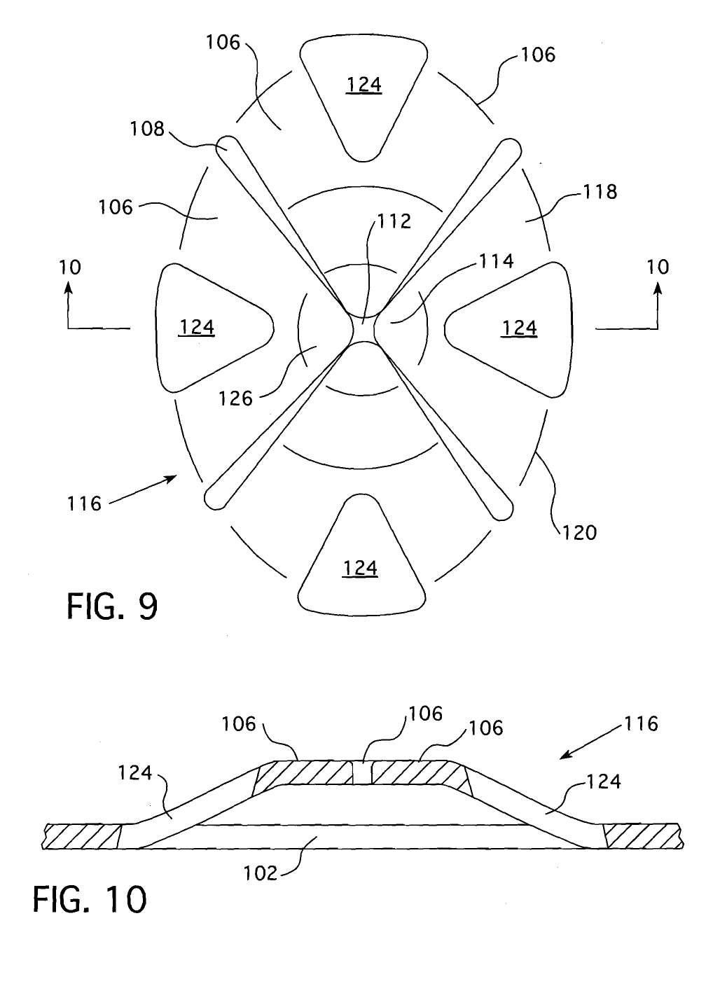

One embodiment of the SPARCH™ is shown in FIGS. 5 and 6 in its undeflected condition. In the embodiments shown in FIG. 5, the SPARCH™ is shown having a circular footprint 104. However, as may be appreciated from FIG. 9, the SPARCH™ may have other footprints such as the oval footprint shown in FIG. 9 to increase the rod contact area around the Y axis. The embodiment illustrated in FIG. 5 has four spring-like, resilient, cantilevered members 106 that extend from the cell wall 102 into the fuel rod support cell 94 (shown in FIG. 4). In the undeflected conditioned, the cantilevered members 106 extend substantially adjacent each other with a space 108 between the adjacent sides 110 of the members and a space 112 between the tips 114 of the members. In the embodiment illustrated in FIG. 5 four such members are shown which collectively form the SPARCH™ 116. However, two or more such members may be employed without departing from the concepts claimed herein. In this embodiment, the cantilevered members 106 each have two legs that are connected at the tips 114 in a generally L-shape, resembling a boomerang, with a distal end 122 of each leg 118, 120 connected to the wall 102 of the support cell 94. The wall 94 and legs 118, 120 of each cantilevered member 106 define a generally triangular shaped opening 124 bordered by an inner surface of the legs 118, 120 and the adjacent wall 102 of the support cell 94. Each of the tips 114 of the cantilevered members 106 are rounded with a space 112 therebetween. A plan view of the embodiments shown in FIG. 5, partially in section, is shown in FIG. 6 with like reference characters designating corresponding components among the various figures.

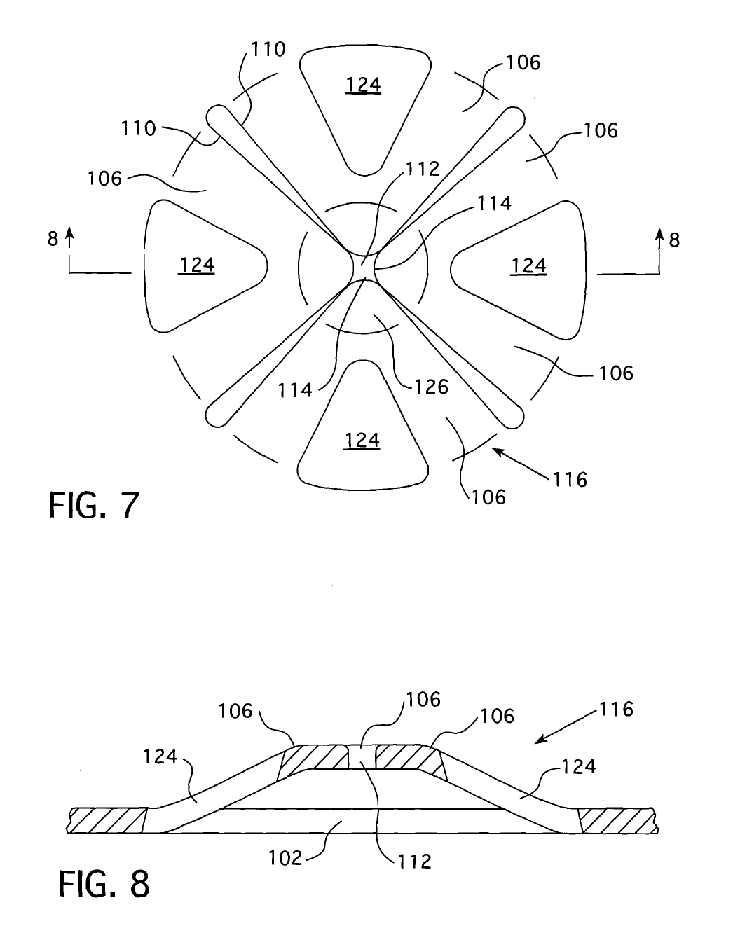

FIGS. 7 and 8 correspond respectively to FIGS. 5 and 6 and show the SPARCH™ 116 in a compressed condition wherein the sides of the tips 114 are drawn together until they make contact at the sides of the tips 114 and lock up to add additional resistance to further compression of the cantilevered members 106. A flattened central region 126, that in this embodiment is generally circular, is provided to substantially match the contour of the fuel element cladding against which it rests to spread the load on the cladding. The spring rate of the SPARCH™ 116 is a function of the length of the cantilevered members 106, i.e., the ligaments or legs 118, 120 and the cutouts 124. These properties may be varied to alter the rod contact area and spring rate for the cantilevered arms in order to optimize rod interface and fretting wear margin.

FIGS. 9 and 10 show a second embodiment of the SPARCH™ 116 with an oval footprint 128. The oval footprint in the flattened area 126 around the tips 114 of the cantilevered members 106 increases the rod contact area along the Y axis of the fuel rods.

One primary benefit of the SPARCH™ rod support system is that when it is used to replace the current dimples, all four sides of the fuel rod will be supported by a spring support feature within the support cell 94 versus only two sides of the rod in conventional designs, which increases the fretting wear margin. Desirably, in each of the embodiments, the deflection of the cantilevered members 106, at the beginning of life of the fuel assembly, is such that the cantilevered members are compressed in a locked condition so that if the opposing springs relax under irradiation, the cantilevered members 106 will spread to continue to force the fuel rod against the opposing spring.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A fuel assembly for a nuclear reactor comprising:
a parallel, spaced array of a plurality of elongated nuclear fuel rods supported between a lower nozzle and an upper nozzle and having an axial length along the elongated dimension of the nuclear fuel rods;
a plurality of spaced support grids arranged in tandem along the axial length of the fuel rods, between the upper nozzle and the lower nozzle, at least partially enclosing an axial portion of the circumference of each fuel rod within a corresponding support cell of the support grids to maintain a lateral spacing between fuel rods, at least one of the support grids comprising;
a plurality of elongated, intersecting straps that define the support cells at the intersection of each four adjacent straps that surround the nuclear fuel rods, a length of each strap along its elongated dimension, between the intersections of the four adjacent straps, forming a wall of the corresponding support cell, at least one wall of the support cell having a dimple extending into the support cell, the dimple comprising a plurality of spring-like, resilient, cantilevered members that extend, substantially adjacent each other, from the wall into the support cell with a distal end of each member being compressed by the fuel rod passing through the support cell so as to exert a lateral force on the fuel rod.

2. The fuel assembly of claim 1 wherein the cantilevered members, in a fully extended position within the support cell, are spaced from each other and when compressed by the fuel rod extending through the support cell the cantilevered members abut against each other to resist further movement towards the wall from which the cantilevered members extend.

3. The fuel assembly of claim 2 wherein the cantilevered members abut against each other at their distal ends.

4. The fuel assembly of claim 3 wherein the cantilevered members respectively have a tip and sides at their distal ends and when they abut they touch at their sides of the distal ends with the tips spaced from the other cantilevered members.

5. The fuel assembly of claim 4 wherein when the cantilevered members abut a space remains between adjacent cantilevered members along a side of each member that adjoins the wall.

6. The fuel assembly of claim 1 wherein the distal end is bent to extend substantially parallel to the surface of the fuel rod extending through the cell, that the distal end contacts.

7. The fuel assembly of claim 1 wherein the cantilevered members each have two legs that are connected at one end in a generally “L”-shape, resembling a boomerang, with a distal end of each leg connected to the wall of the support cell and the wall and legs of each cantilevered member defining a generally triangular shaped opening bordered by an inner surface of the legs and the adjacent wall of the support cell.

8. The fuel assembly of claim 1 wherein the dimple is generally hemispherical in shape.

9. The fuel assembly of claim 1 wherein an outline of the dimple is generally oval in shape.

10. The fuel assembly of claim 1 wherein the dimple is formed from four cantilevered members.

11. The fuel assembly of claim 1 wherein the distal ends of the cantilevered members are rounded.

12. The fuel assembly of claim 1 wherein the support cell has four of the walls and each of the walls has the dimple extending from the corresponding wall into the support cell.

13. The fuel assembly of claim 1 wherein the dimple is a variable rate spring support.

14. The fuel assembly of claim 13 wherein the dimple exhibits a stepped change in its strength resisting further deflection towards the wall from which it extends after being compressed toward the wall a preselected distance.

15. A nuclear reactor power generating system having a nuclear reactor including a fuel assembly comprising:
a parallel, spaced array of a plurality of elongated nuclear fuel rods supported between a lower nozzle and an upper nozzle and having an axial length along the elongated dimension of the nuclear fuel rods;
a plurality of spaced support grids arranged in tandem along the axial length of the fuel rods, between the upper nozzle and the lower nozzle, at least partially enclosing an axial portion of the circumference of each fuel rod within a corresponding support cell of the support grids to maintain a lateral spacing between fuel rods, at least one of the support grids comprising;
a plurality of elongated, intersecting straps that define the support cells at the intersection of each four adjacent straps that surround the nuclear fuel rods, a length of each strap along its elongated dimension, between the intersections of the four adjacent straps, forming a wall of the corresponding support cell, at least one wall of the support cell having a dimple extending into the support cell, the dimple comprising a plurality of spring-like, resilient, cantilevered members that extend, substantially adjacent each other, from the wall into the support cell with a distal end of each member being compressed by the fuel rod passing through the support cell so as to exert a lateral force on the fuel rod.
